(19) United States
(12) Patent Application Publication
(10) Pub. No.: US 2013/0039067 A1
(43) Pub. Date: Feb. 14, 2013

(54) RETRACTABLE LIGHT-EMITTING STRUCTURE

(71) Applicant: Tsui-Yun WONG, Taipei City (TW)

(72) Inventor: Tsui-Yun WONG, Taipei City (TW)

(21) Appl. No.: 13/208,402

(22) Filed: Aug. 12, 2011

(51) Int. Cl. F21S 4/00

(52) U.S. Cl. 362/249.06; 362/249.01

(57) ABSTRACT

The retractable, light-emitting structure comprises of a string structure that has several light-emitting components: a fixed housing with openings at each end and a mobile housing with openings at each end. The ends of each housing are matched up to create a retractable lid that displays the emitting light inside the fixed housing. The mobile housing would inwardly retract along the fixed housing to make the retractable cover. These structures are ideally installed on the eaves or edges of a housing complex and are controlled by a remote control device that allows for color customization and the ability to control the mobile housing in accordance to different holidays, festivals, and user preference.

### BACKGROUND OF THE INVENTION

1. Field of the Invention

The present invention, generally, relates to a light-emitting structure that is disposed on walls, beneath draining tubes or under eaves. Functions include user customization of the device's opening and closing feature pending on varying occasions and situations.

2. Description of the Prior Art

Traditional, decorative lights are installed for holidays and occasions such as Christmas, the Fourth of July, Halloween, etc. . . . The repetitive cycle of buying, unloading, installing, breaking down, packaging, and storing these festive lights can be an exhaustive process on any family. Furthermore, there is a constant exposure to risk of injury each time these lights need to be installed. In essence, there is a huge amount of risk, effort, money, and time invested into the installation of outdoor, decorative lights.

The aforementioned problems with outdoor, decorative light installations have plagued households for a long time. As a result, the best solution would be a permanent and discreet light installation that would be entirely customizable in accordance to respective holidays and festivals. Furthermore, the adjustable light would allow users to open and close the structure in order to hide the appearance of the lights until the next, desired usage period.

### SUMMARY OF THE INVENTION

The main objective of the present invention is to provide a light-emitting structure that includes a retractable cover that is customizable according to different holidays or user demands. The structure would be permanent and would not require constant installation and breakdown.

The second objective of the present invention is to provide a coverable light-emitting structure that is easy-to-use and requires a simple installation process.

The third objective of the present invention is to provide a coverable light-emitting structure that has multiple types of connections such as direct or angle connection. This would allow the installation of these light-emitting structures to adapt to houses of all different categories, dimensions, and structures.

To achieve the above objectives, the retractable light-emitting structure comprises of a string structure that has a multitude of light-emitting components. A fixed housing, with openings at each end, is connected with a mobile housing, which also has openings at each end, by matching the openings. The mobile housing moves inwardly along the fixed housing in order to create the retractable lid for the light-emitting structure. Users have the ability to cover-up or display the string of lights inside a rod or tube-like structure in accordance to different holidays, festivals, and user preferences.

Each end of the string structure is an electric connector that is connected to a power source. The retractable, light-emitting structures can be powered through the connection of other retractable, light-emitting structures through the connection of each structure's electric connectors. Essentially, these structures can be interconnected and powered through their electric connectors to form a long chain or string of retractable, light-emitting structures.

The light-emitting component is LED.

The LED, light-emitting component is fixed within the fixed housing through the fastening of two nuts.

The retractable, light-emitting structure includes two fixing bases, which allow the structure to be installed onto walls, eves, and edges. Each fixing base is connected to the light-emitting structure through the connection of screws and nuts between the openings of the fixed and moving housings and the fixing bases.

A washer is disposed between one end of the moving mobile housing and one end of the fixed housing, the two ends are corresponding to each other, so that the threaded tracks of the place holder and the connecting nuts of the fixed housing are tighter, the friction of the side surfaces of the fixed housing and the mobile housing is decreased by the washers in order to smoothly retract the mobile housing without noise.

Each of the two outer end surfaces of the fixed housing has a groove. Each of the two inner end surfaces of the mobile housing has a stopper that corresponds to the groove of the fixed housing. The stopper is movable along the groove so as to let the mobile housing move along the fixed housing.

The mobile housing has a hook latch, in which a user is able to use the extension hook to open and close the structure.

Other and further features, advantages, and benefits of the invention will become apparent in the following description, taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits, and advantages of the preferred embodiments of the present invention will be readily understood by the accompanying drawings and detailed descriptions, wherein:

FIG. 1A illustrates a 3-D exploded sketch of the retractable light-emitting structure of the present invention;

FIG. 1B illustrates a 3-D assembly sketch of the retractable light-emitting structure of the present invention;

FIG. 2A illustrates a structural sketch of a fixed housing of the retractable light-emitting structure of the present invention;

FIG. 2B illustrates a lateral sketch of the fixed housing of the retractable light-emitting structure of the present invention;

FIG. 3A illustrates a structural sketch of a mobile housing of the retractable light-emitting structure of the present invention;

FIG. 3B illustrates a lateral sketch of the mobile housing of the retractable light-emitting structure of the present invention;

FIG. 4 illustrates a lateral sketch of matching the movable housing and the fixed housing of the retractable light-emitting structure of the present invention;

FIG. 5A illustrates a half-opening sketch of the movable housing of the fixed housing of the retractable light-emitting structure of the present invention;

FIG. 5B illustrates a full-opening sketch of the movable housing of the fixed housing of the retractable light-emitting structure of the present invention; and

FIG. 6 illustrates an application sketch of the retractable light-emitting structure of the present invention.

### DETAILED DESCRIPTION OF THE INVENTION

The following preferred embodiments and figures will be described in detail so as to achieve aforesaid objects.

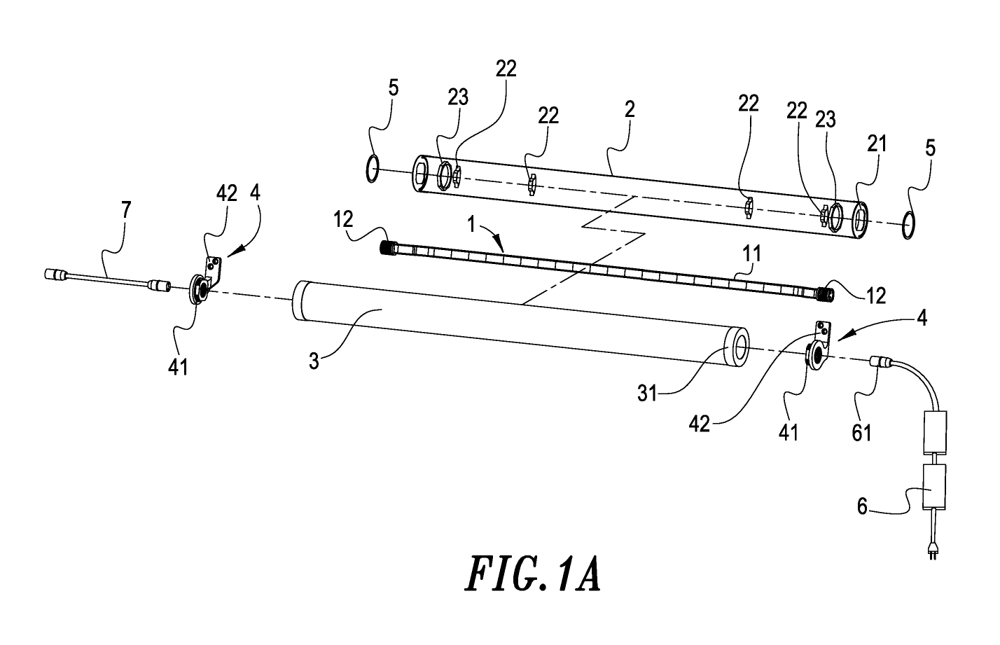

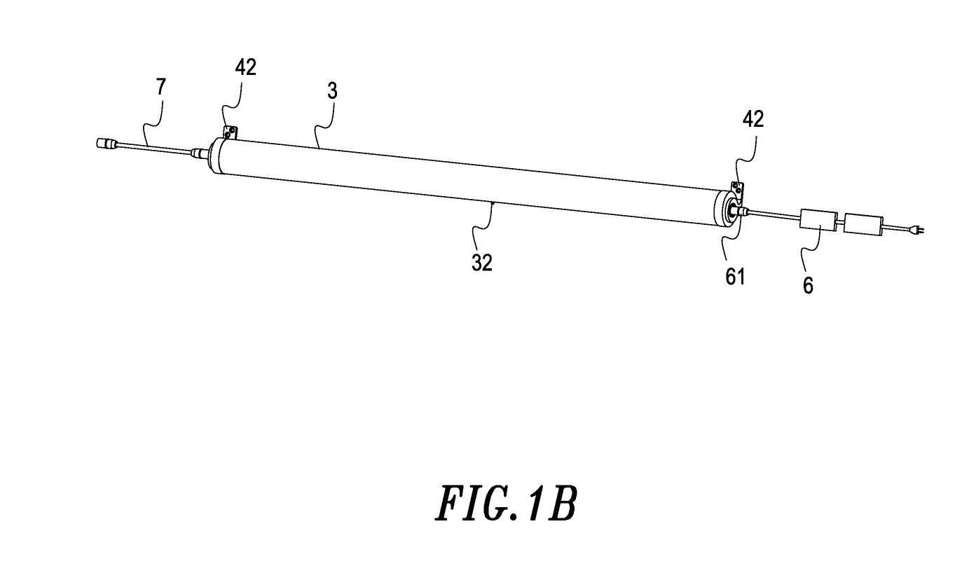

With references to FIG. 1A and FIG. 1B, which illustrate a 3-D exploded sketch of the retractable light-emitting structure of the present invention and a 3-D assembly sketch of the retractable light-emitting structure of the present invention. As shown in figures, the retractable light-emitting structure includes a LED strip light (light string structure) 1 having a plurality of LED bulbs 11, a fixed housing 2, each end of which has one fixed housing opening 21, and a mobile housing 3, each end of which has one mobile housing opening 31, wherein a plurality of brackets 22 and two connecting nuts 23 are disposed in the fixed housing 2, the brackets 22 are fixed in the internal of the fixed housing 2 through the LED strip light 1, the mobile housing 3 has a hook latch 32, therefore a user is able to hook the hook latch 32 through a rod member in order to lift or close the mobile housing 3.

The retractable light-emitting structure can be added two place holders 4, each place holder 4 has a plurality of threaded tracks 41 and a plurality of mounting holes 42, one end of the place holder 4 is inserted into the mobile housing opening 31 of the mobile housing 3 and the fixed housing opening 21 of the fixed housing 2, so that the threaded tracks 41 of the place holder 4 and the connecting nuts 23 of the fixed housing 2 are matched to each other, the mounting holes 42 is capable of fixing the lifting light-emitting structure, connected with the place holders 4, on a surface. A washer 5 is disposed between one end of the mobile housing 3 and one end of the fixed housing 2, the two ends are corresponding to each other, so that the threaded tracks 41 of the place holder 4 and the connecting nuts 23 of the fixed housing 2 are tighter, the friction of the side surfaces of the fixed housing 2 and the mobile housing 3 is decreased by the washers 5 in order to smoothly retract the mobile housing 3 without noise.

Each end of the LED strip light 1 is disposed an LED connector 12 that is connected with a power source. The retractable light-emitting structure can be further added a transformer 6 with a power connector 61, the power connector 61 is connected with the LED connector 12 of the LED strip light 1 for providing power to the LED strip light 1. The retractable light-emitting structure further have a angle connector 7, one end of the angle connector 7 is connected with the LED connector 12 of the LED strip light 1.

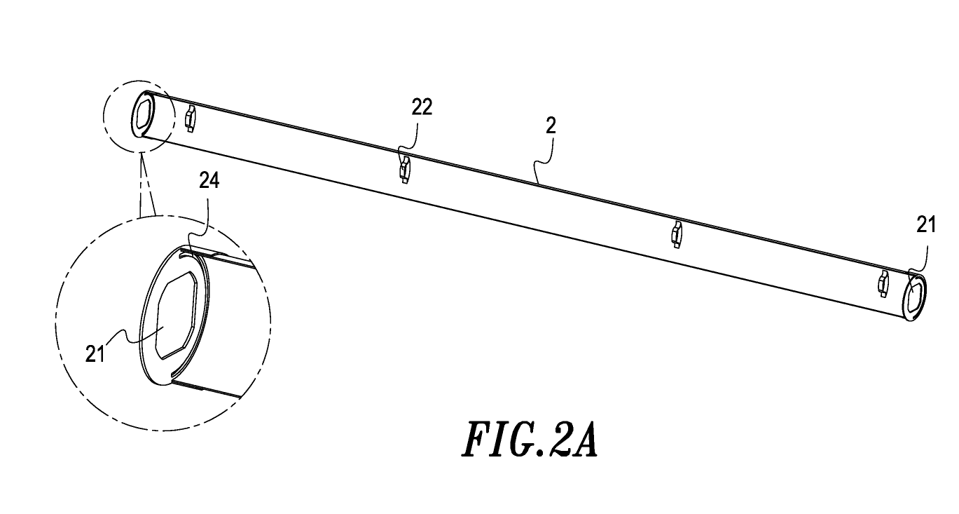

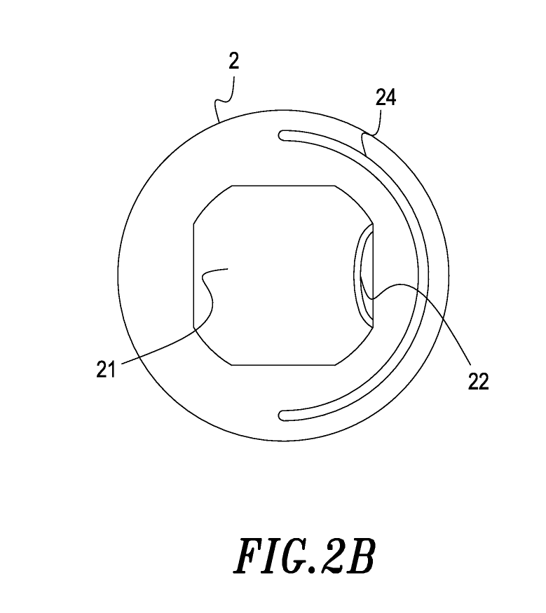

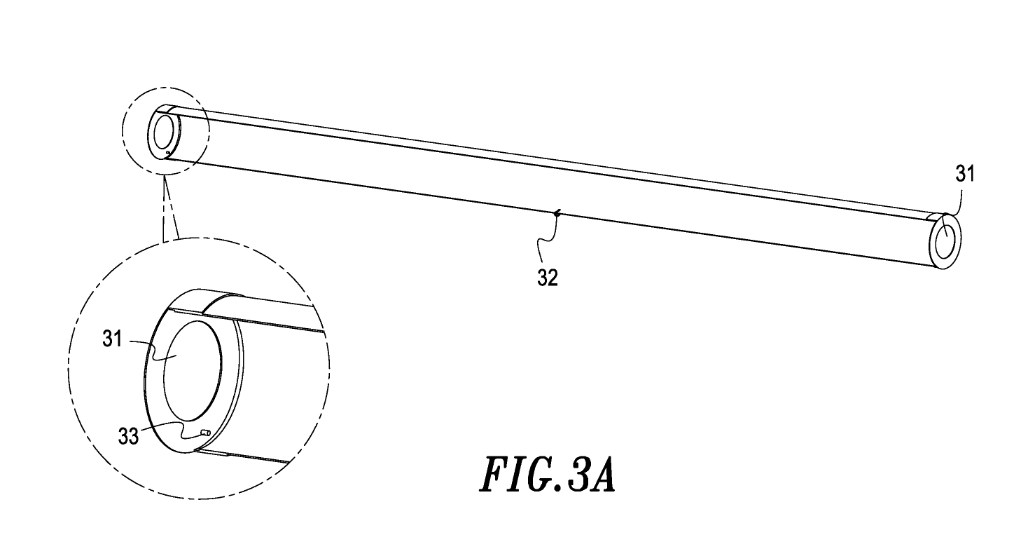

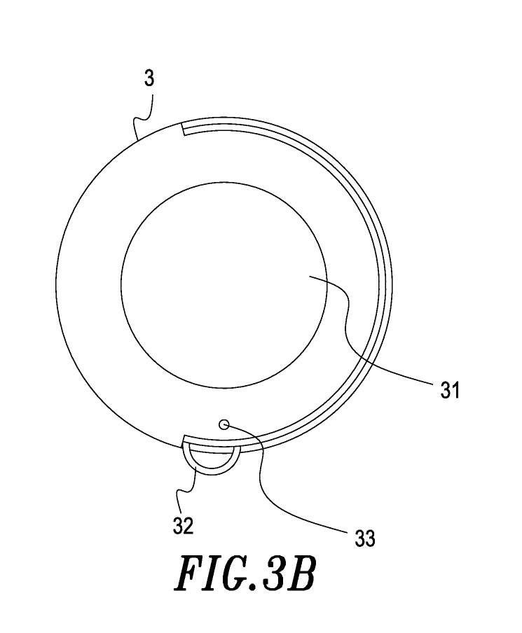

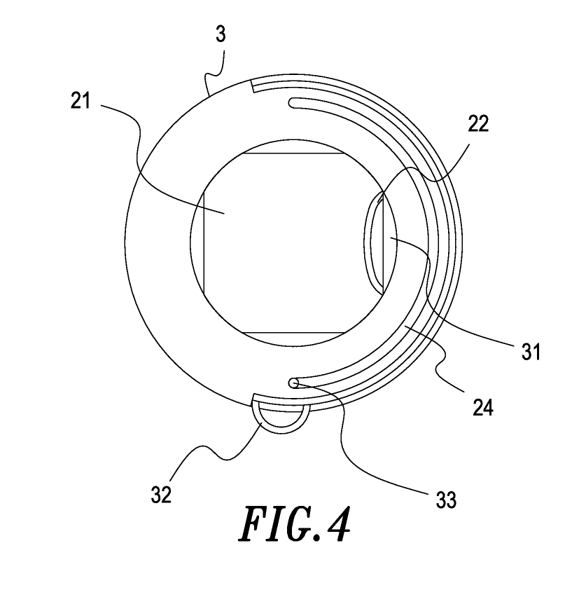

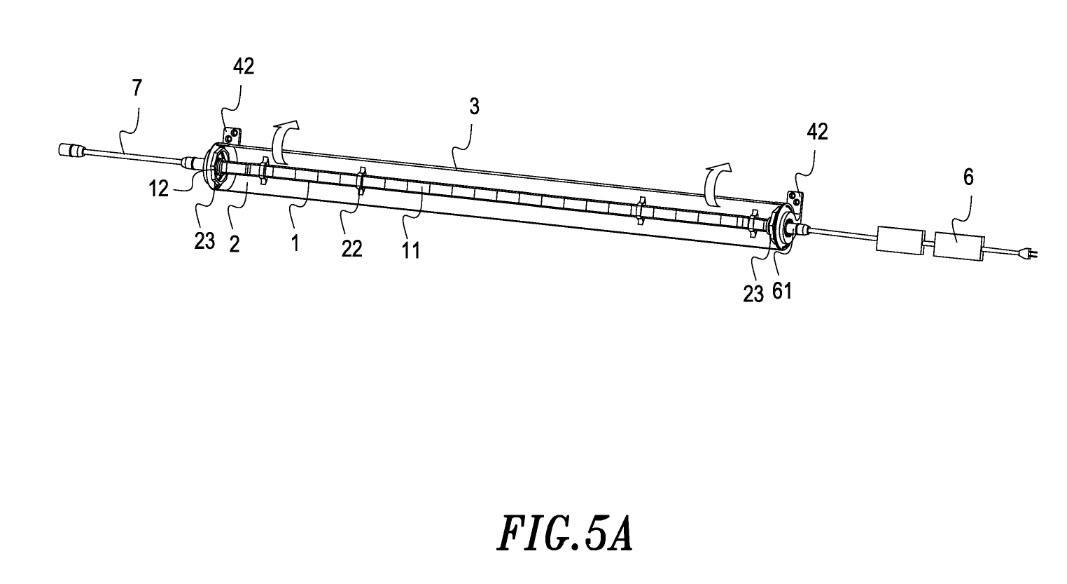

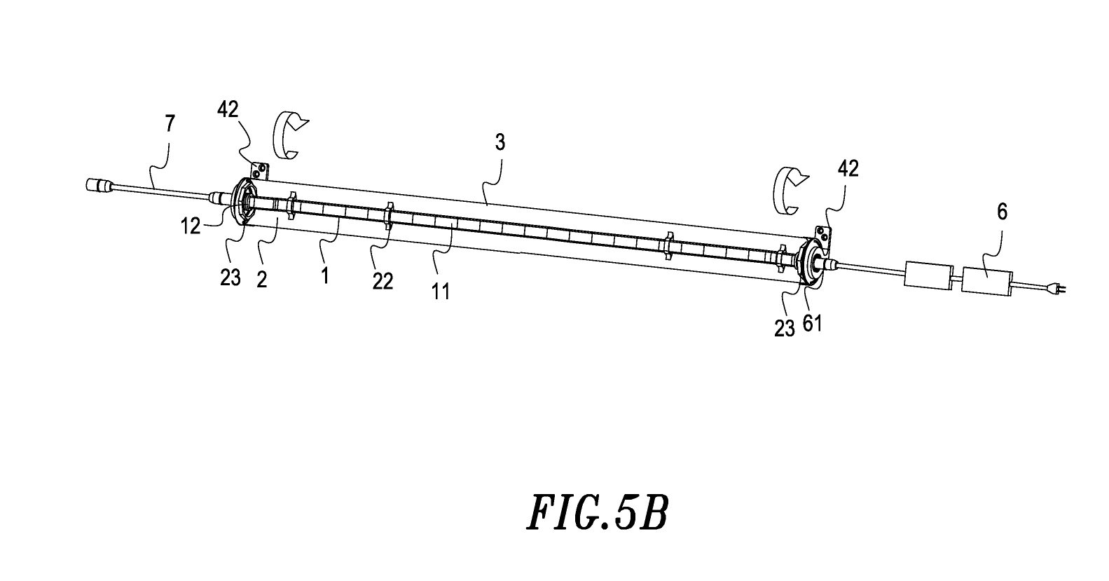

As shown in FIG. 2A and FIG. 2B, each of the two outer end surfaces of the two ends of the fixed housing 2 has a groove 24. As shown in FIG. 3A and FIG. 3B, each of the two inner end surfaces of the two ends of the mobile housing 3 has a stopper 33 that is corresponding to the groove 24 of the fixed housing 2, the stopper 33 is movable along the groove 24, as shown in FIG. 4, so as to let the mobile housing 3 be movable on the fixed housing 2. Hence, the two ends of the mobile housing 3 and the two ends of the fixed housing 2 are connected to each other. As shown in FIG. 5A and FIG. 5B, the mobile housing 3 can be outwardly lifted along the fixed housing 2 in order to present the LED strip light 1 inside the fixed housing 2, FIG. 5A is a state of half-open, FIG. 5B is a state of full-open. Likewise, the lifted mobile housing 3 can be closed along the fixed housing 2, as shown in FIG. 1B, that is a state of full-close.

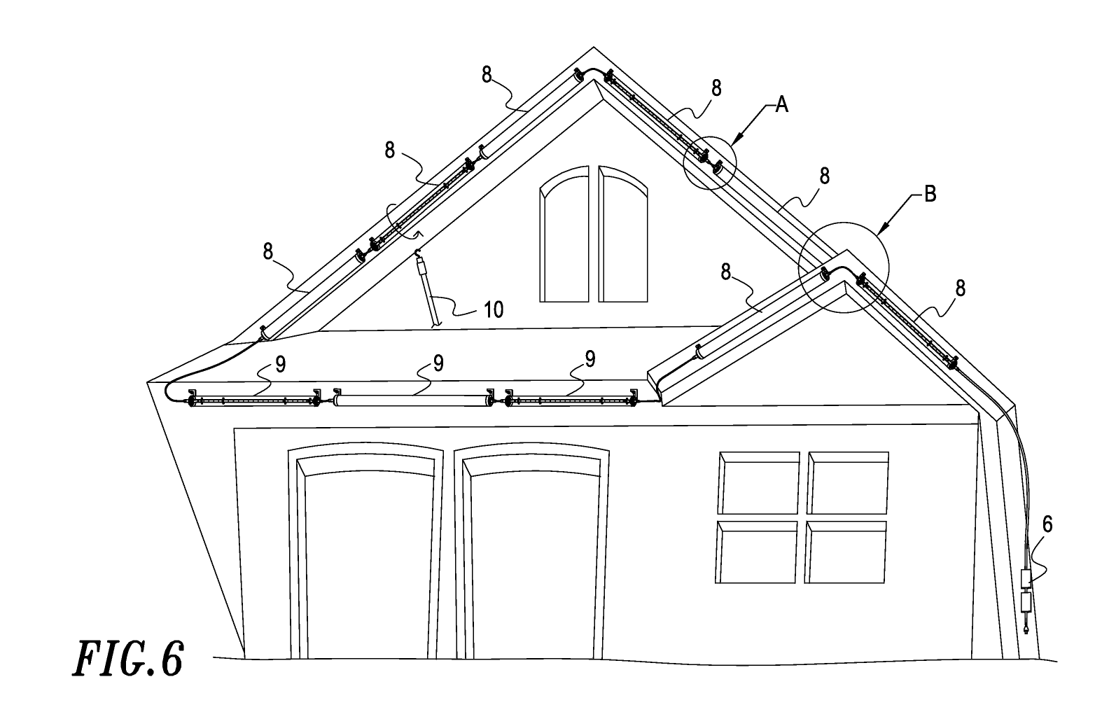

The present invention can be disposed on a house depending on the location of the practical house structure, such as by wall-hanging or suspending, which are the ways of disposing the present invention on a wall and beneath draining tubes or under eaves. As shown in FIG. 6, the retractable light-emitting structure 8 is disposed on a house through the way of wall-hanging; the other retractable light-emitting structure 9 is disposed under eaves through the way of suspending. Thus, a user is able to lift the mobile housings via an extension hook 10 in order to display LED strip lights inside the mobile housings. Such that, the mobile housings are lifted to present the light string structures while in some important holidays; otherwise, the mobile housings are closed. In the figure, some of the mobile housings are lifted to open, and some are not, that is to say the user can change the states according to different situations. Aside from disposing the present invention beneath eaves, other locations of the house are also viable options. It is fully customizable to the customer's preferences. Accordingly, the ways of connection can also be varied. As it can be seen in the figure, if the distance between two lifting light-emitting structures 8 is short, a direct connection A is used; angled connection is the alternative option. Hence, the light-emitting structure is malleable to houses with different dimensions and structures.

The LED strip light will be controlled by a remote control that will have the ability of changing light modes and color preferences. Compared to prior arts, the retractable light-emitting structure of the present invention has the following advantages listed below:
1. The present invention can be varied with different holidays or user demands, and does not require constant assembly and disassembly.
2. The present invention is a simple light structure that requires easy installment and simplistic usage. The light structure has different lighting modes that correspond to different holidays and customer demands. For instance, red-white-blue would be ideal for the 4^{th} of July. For other holidays, festivals, and occasions, variations/combinations of red, yellow, blue, green, purple, and white could be utilized. could be used for Christmas. Control buttons corresponding to the modes are available to the user through the remote control.
3. The present invention has different types of connections and installments that accommodate houses with different categories, dimensions and structures.
4. The present invention requires minimal maintenance and easy dismantlement.

Therefore, broken lights can be changed sectionally in order to avoid changing an entire line of lights.
5. The present invention is disposed outdoors with a retractable cover so that it can protect the lights from harmful and uncleanly exterior elements.
6. The present invention possesses the ability to protect itself from rain and sunshine, when not in use, through the application of the retractable cover. In term the light-emitting structure will have an extended lifespan.

Although the invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A retractable light-emitting structure comprising:
a light string structure, having a plurality of light-emitting components; a fixed housing with each end of the fixed housing having an opening, the light string structure being disposed in the fixed housing; and
a mobile housing that connects to the fixed housing through the matching of each piece's respective openings at either end and, in turn, allows the mobile housing to outwardly move along the fixed housing in order to display the light emitting component.

2. The retractable light-emitting structure according to claim 1, wherein each end of the light string structure is disposed an LED connector that is connected with a power source.

3. The retractable light-emitting structure according to claim 2 further comprising a transformer with a power connector, the power connector being connected with the LED power connector of the light string structure for providing power to the light string structure.

4. The retractable light-emitting structure according to claim 2 further comprising an angle connector, one end of the angle connector being connected with the LED power connector of the light string structure, another end of the angle connector being connected with another light string structure.

5. The retractable light-emitting structure according to claim 1, wherein the light-emitting component is an LED.

6. The retractable light-emitting structure according to claim 1, wherein a plurality of brackets and two connecting nuts are disposed in the fixed housing, the bracket being fixed in the internal of the fixed housing through the light string structure.

7. The retractable light-emitting structure according to claim 6 further comprising two place holders, each place holder having a plurality of threaded tracks and a plurality of mounting holes, one end of the place holder being inserted into the mobile housing opening of the mobile housing and the fixing housing opening of the fixed housing, so that the threaded tracks of the place holder and the connecting nuts of the fixed housing are matched to each other.

8. The retractable light-emitting structure according to claim 7, wherein a washer is disposed between one end of the mobile housing and one end of the fixed housing, the two ends being corresponding to each other, so that the threaded tracks of the place holder and the connecting nuts of the fixed housing are tighter, the friction of the side surfaces of the fixed housing and the mobile housing being decreased by the washers in order to smoothly retract the mobile housing without noise.

9. The retractable light-emitting structure according to claim 1, wherein each of the two outer end surfaces of the two ends of the fixed housing has a groove.

10. The retractable light-emitting structure according to claim 9, wherein each of the two inner end surfaces of the two ends of the mobile housing has a stopper that is corresponding to the groove of the fixed housing, the stopper being movable along the groove so as to let the mobile housing be movable on the fixed housing.

11. The retractable light-emitting structure according to claim 1, wherein the mobile housing has a hook latch.
